(19) United States
(12) Patent Application Publication
(10) Pub. No.: US 2016/0088359 A1
(43) Pub. Date: Mar. 24, 2016

(54) MOBILE NOTIFICATION OF TELEVISION PROGRAMS

(71) Applicant: Verizon Patent and Licensing Inc., Arlington, VA (US)

(72) Inventors: Aravind Vaidhyanathan, Tamil Nadu (IN); Vijayan Radhakrishnan, Tamil Nadu (IN); JanardhanReddy Tripuram, Telagana (IN); Venkatesan M. Sriraman, Tamil Nadu (IN); Sivasubramanian Parthasarathy, Pondicherry (IN); Kavitha PanneerSelvam, Tamil Nadu (IN); Deepak Natarajan, Tamil Nadu (IN)

(21) Appl. No.: 14/492,626

(22) Filed: Sep. 22, 2014

(51) Int. Cl. H04N 21/488; H04N 21/41; H04N 21/436; H04N 21/433; H04N 21/442; H04N 21/482; H04N 21/435

(52) U.S. Cl. CPC H04N 21/4882; H04N 21/4821; H04N 21/4126; H04N 21/435; H04N 21/4334; H04N 21/44231; H04N 21/43615

(57) ABSTRACT

A set-top box (STB) causes a display device to present a notification during a time period. The notification identifies digital contents, such as television show, available for access via the STB. If no response to notification is received during the time period or the display device or STB is inactive, a notification message is sent to an associated user device. The notification message may be generated based on metadata extracted from electronic programming guide (EPG) data, and the notification message may include an indication that the digital contents are available for access via the STB. The notification message may also identify an available action related to the digital contents. For example, the action may relate to recording the digital contents or requesting another notification or notification message related to another broadcast of the digital contents. Response data requesting execution of the action may be received from the user device.

### BACKGROUND

Set-Top Boxes (STBs) may provide digital contents associated with a subscription television service received via a network, such as a cable network and/or an optical fiber network. For example, the STBs may receive multicast stations and/or video-on-demand (VOD) contents provided through the subscription television service. The STBs may perform various processing of the received digital content, such as to decode the digital contents, perform digital rights management and authentication control functions (e.g., decryption of the digital contents), etc. and provide the processed digital contents for presentation on display devices (e.g., televisions) connected to the STBs. A user may use an input device, such as a remote control device, to provide an input to cause the STB to switch channels, configure the STB (e.g., turning on closed captioning, modifying audio/vision output formats, etc.), and/or control other functions on the STB. For example, a user may submit an input related to controlling a digital video recorder (DVR) associated with the STB, accessing an electronic programming guide (EPG) identifying contents available via the channels, accessing a VOD catalog identifying contents available via VOD, and/or activating other functions (e.g., widgets) available via the STB.

### BRIEF DESCRIPTION OF THE DRAWINGS

FIG. 1A shows an exemplary electronic programming guide (EPG) interface that, according to one implementation, may be used to select a program that is available via a set-top box (STB);

FIG. 1B shows an exemplary notification of the selected program that, according to one implementation, may be provided via the STB;

FIG. 1C shows an exemplary notification message that may be presented by another device, according to one implementation, when a response is not received to the notification of FIG. 1B;

FIGS. 2A and 2B shows exemplary environments for providing the notification message of FIG. 1C, according to two implementations;

FIG. 3 shows exemplary components of a device included in the environments of FIGS. 2A and 2B, according to one implementation;

FIG. 4 shows exemplary components of an STB included in the environments of FIGS. 2A and 2B, according to one implementation;

FIG. 5 shows exemplary data that may be included in one or more of the notification of FIG. 1B or the notification message of FIG. 1C, according to one implementation; and

FIG. 6 shows an exemplary process for presenting the notification message of FIG. 1C according to one implementation.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

In exemplary embodiments described herein, a set-top box (STB) may cause a display device to present a notification during a time period. The notification may identify digital contents, such as a television show, available for access by the user via the STB. If no response to notification is received from the user during the time period, a user device associated with the user may be identified, and a notification message may be sent to the user device. For example, the notification message may be sent to the user device if the STB or the display device is inactive during the time period. The notification message may be generated based on metadata extracted from electronic programming guide (EPG) data, and the notification message may include an indication that the digital contents are available for access via the STB. The notification message may also include data identifying an available action related to the digital contents. For example, the action may relate to causing a digital video recorder (DVR) to store the digital contents or to requesting another notification or notification message related to a future broadcast of the digital contents. Response data, requesting execution of the action, may be received from the user device, and the STB may cause the action to be executed.

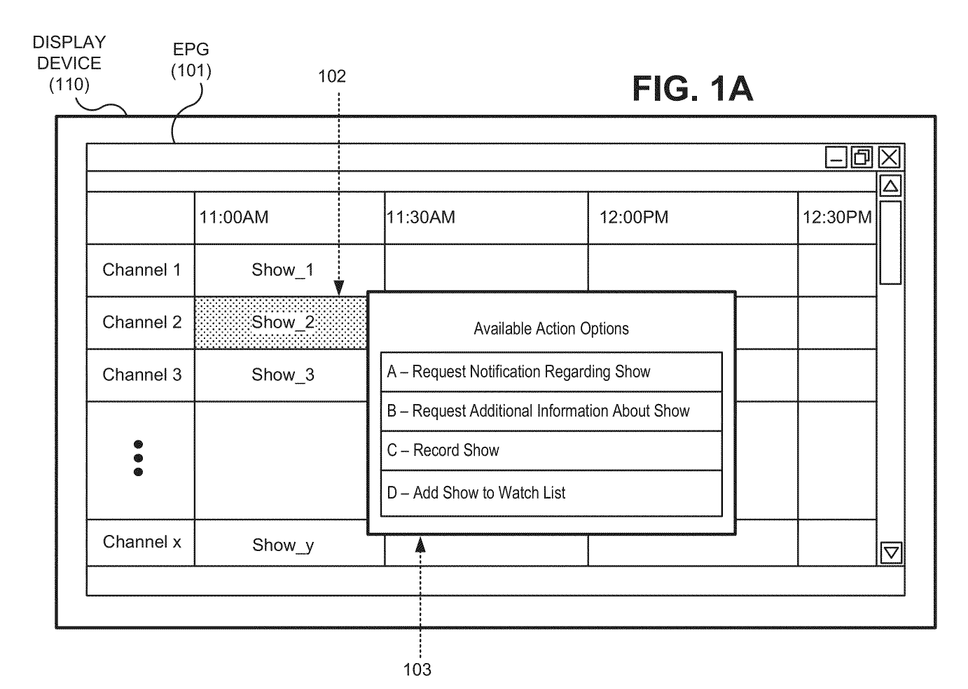

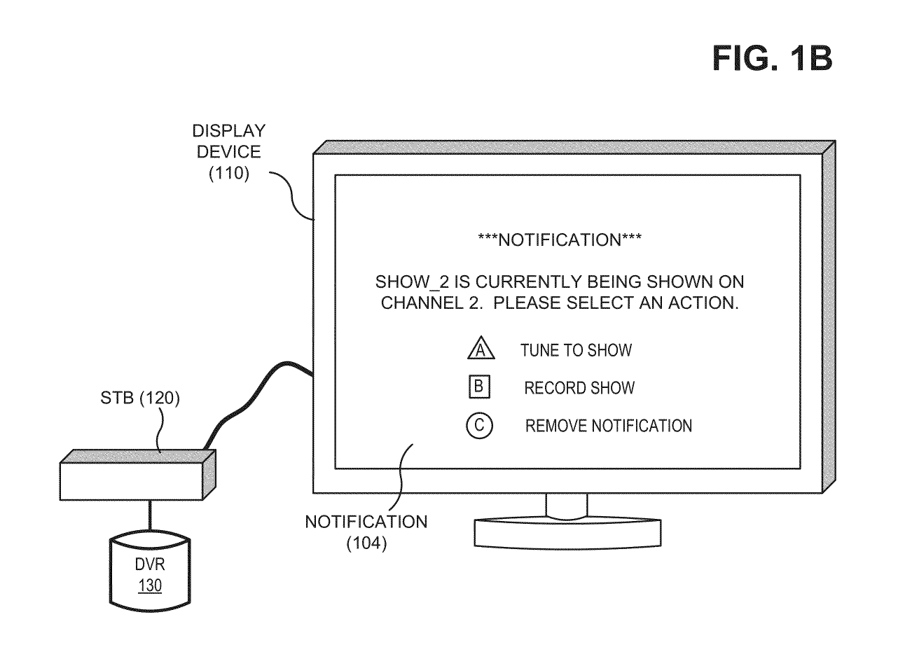

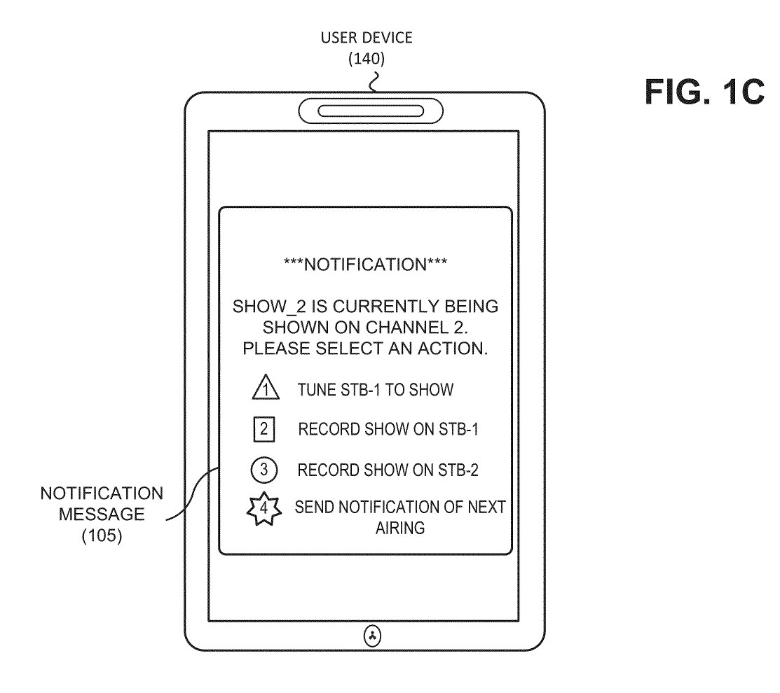

Principles related to a disclosed system and method are now described with respect to an example shown in FIGS. 1A-1C. FIG. 1A shows an exemplary EPG interface 101 presented on a display device 110 according to one implementation. As shown in FIG. 1A, EPG interface 101 may include data identifying programs (also referred herein as shows or digital contents) shown on different channels. In the example shown in FIG. 1A, EPG interface 101 may include a table in which different channels (or stations) are associated with rows (the channels may be identified in the left column of EPG interface 101), and different times are associated with columns (the times may be identified in a top row of EPG interface 101). Each table entry of EPG interface 101 may identify metadata (e.g., an identifier) for a show being presented on a channel associated with the entry and at a time associated with the entry. A user may navigate among the entries in EPG interface 101 to view programs associated with different channels and/or times. For example, a user may submit an input (e.g., via a remote control device or other input device) to move up or down to select between different channels and/or move left or right to select between different times.

Display device 110 may include a digital or analog display via which a user may view multimedia contents and a notification (shown in FIG. 1B as notification 104) regarding the broadcast of a selected program. Display device 110 may be any device that can receive and display multimedia contents delivered through an STB (shown as STB 120 in FIG. 1B).

As further shown in FIG. 1A, EPG interface 101 may include a program selection indication 102 that identifies a program (corresponding to “Show_2” in FIG. 1A) selected by a user through EPG interface 101. For example, program selection indication 102 may include a particular color, saturation, brightness, font, graphical symbol, or other indication to distinguish the selected program from other programs identified within EPG interface 101.

In one implementation, EPG interface 101 may include an option to enable a user to request notifications related to multiple shows based on metadata associated with the shows. For example, EPG interface 101 may enable a user to select a series (e.g., a group of shows having a similar identifier); different broadcasts (e.g., re-broadcasts) of a particular show; shows in a selected genre (e.g., comedies, cartoons, musicals, etc.); shows featuring a common actor; shows having similar metadata (e.g., different events in a common sport), etc.

Selection of a program in EPG interface 101 (e.g., as indicated by program selection indication 102) may cause display device 110 to present an action menu 103. Action menu 103 may present options available to a user with respect to the selected digital programming. In the example shown in FIG. 1A, action menu 103 may include options of “A: Request Notification Regarding Show”; “B: Request Additional Information About Show”; “C: Record Show”; and “D: Add Show to Watch List”.

A user selection of the “A: Request Notification Regarding Show” action may result in the presentation of a notification as described below with respect to FIG. 1B. If the user selects the “B: Request Additional Information About Show” action, display device 110 may present additional metadata regarding the selected show, such as to modify EPG interface 101 to present data identifying an actor, a genre, a rating, a summary, a future broadcast time, or other information about the selected show. If the user selects an input selecting the “C: Record Show” action, instructions may be sent to a device (e.g., DVR 130 in FIG. 1B) to record the selected digital programming. A selection of the “D: Add Show to Watch List” action may cause metadata about the digital programming, such as an identifier of the show, to be stored and presented in a watch list. It should be appreciated that action menu 103 shown in FIG. 1A is intended merely to provide examples of possible actions, and that action menu 103 may include additional, fewer, or different actions than those shown in FIG. 1A.

FIG. 1B shows an exemplary notification 104 that may be presented by display device 110, in one implementation, if the user selects the “A: Request Notification Regarding Show” action in action menu 103. Notification 104 may relate to a selected program (e.g., a program associated with program selection indication 102). In the example shown in FIG. 1A, selection indication 102 corresponds to “Show_2” being shown on “Channel 2” at 11:00 AM. Notification 104 may present information indicating that the selected show is being shown on the particular channel, as depicted in FIG. 1B. Display device 110 may display notification 104 at a particular time associated with the program (e.g., 10 minutes prior to the start of the program).

Notification 104 may be generated by STB 120 based on information included in EPG interface 101 and based on instructions received via action menu 103. For example, STB 120 may store metadata associated with the selected show based on a section of the “A: Request Notification Regarding Show” action in action menu 103. STB 120 may use the metadata to populate a form to generate notification 104 and may forward the populated form to display device 110 for presentation to a user.

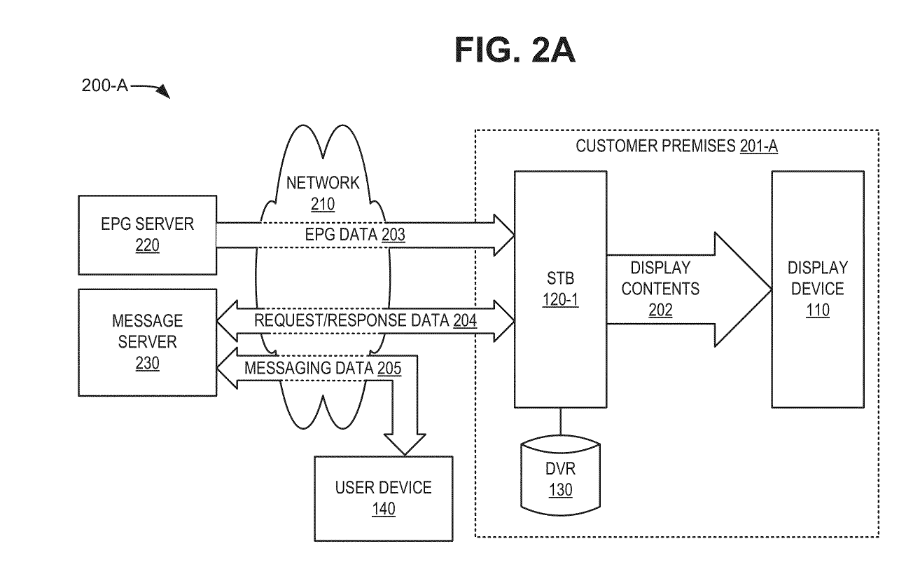

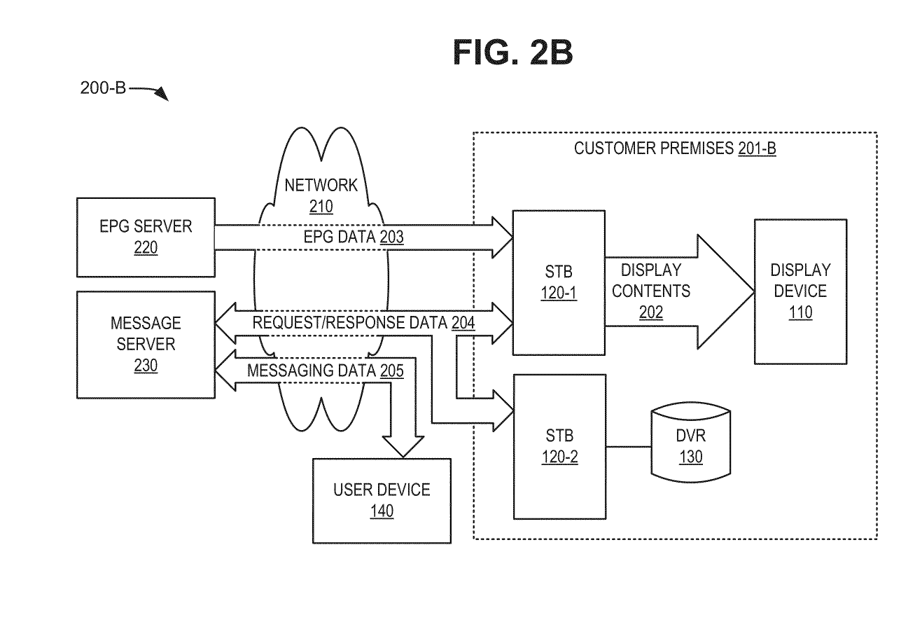

STB 120 may provide contents (shown as display contents 202 in FIG. 2, discussed below) that selectively include, for example, EPG interface 101, notification 104, and/or digital contents (e.g., the programs identified by EPG interface 101). STB 120 may include, for example, an input component to receive data (shown in FIG. 2 as EPG data 203, discussed below) to form EPG interface 101. STB 120 may further include a tuner to selectively access a portion of received digital contents to provide a selected channel for display by display device 110.

In one implementation shown in FIG. 1B, notification 104 may include action options related to the show, such as “A: Tune to Show”; “B: Record Show”; and “C: Remove Notification.” Selection of the “A: Tune to Show” option may cause STB 120 to tune to a channel associated with the show and process the show for presentation on display device 110. Selection of option “B: Record Show” may cause a DVR 130 to record data associated with the show, such as to cause STB 120 to tune to a channel associated with the show and provide the show for recording by DVR 130.

DVR 130 may include storage to store digital contents presented on a selected channel at a particular time. For example, DVR 130 may include a memory to store digital contents decoded by STB 120. DVR 130 may further process the digital content for storage and/or process the stored content for presentation via display device 110.

FIG. 1C shows an exemplary notification message 105 that may be sent to a user device 140 when certain conditions occur, such as when display device 110 and/or STB 120 are inactive (e.g., turned off, in sleep mode, or otherwise prevented from displaying notification 104) at a time when notification 104 is scheduled to be displayed. Additionally, notification message 105 may be sent if no response (e.g., a selection of one of the options A-C shown in FIG. 1B) is received within a threshold time after notification 104 is displayed. Notification message 105 may be, for example, a text string, a short message service (SMS) message, e-mail message, an image file, multimedia content, a web page, data presented by an application running on user device 140, an audio message, etc. As shown in FIG. 1C, notification message 105 may include metadata associated with the selected program, such as information identifying the program (“Show_2”) and a channel (“Channel_2”) broadcasting the program.

User device 140 may include, for example, a digital telephone (e.g., a device implementing voice over internet, or VoIP, technology), a cellular telephone, a smart phone, a PDA (e.g., that can include a radiotelephone, a pager, Internet/intranet access, etc.), a laptop computer (e.g., with a WLAN network card), or other types of communication devices. In one implementation, user device 140 may include a computing device that is capable of receiving data identifying the contents of notification message 105. In another example, user device 140 may include another STB 120 (the additional STB not shown in FIGS. 1A-1C), that differs from the STB 120 presenting notification 104.

As shown in FIG. 1C, notification message 105 may prompt a user of mobile device 140 to select between different action options related to the show and may include information regarding the action options. In the example shown in FIG. 1C, notification message 105 may include actions options of “1: Tune STB-1 to Show”; “2: Record Show on STB-1”; “3: Record Show On STB-2” that did not receive the input; and “4: Send Notification of Next Airing” (airing=broadcast).

The selection of option “1: Tune to Show” may cause user device 140 to send a request to a first STB 120 (“STB-1”) that presented notification 104. The request may cause first STB 120 to tune to a channel associated with the show and process the show for presentation on display device 110. Selection of option “2: Record Show On STB-1” may cause user device 140 to send a request to first STB 120 and/or DVR 130 to record data associated with the show. For example, the record request may cause the first STB 120 to tune to the channel associated with the show and process the show for recording by DVR 130.

Selection of option “3: Record Show On STB-2” may cause user device 140 to send a request to a second STB 120 (“STB-2” not shown on FIGS. 1A-1C) that differs from STB-1. The request associated with option “3” may cause the second STB 120 to record data associated with the show, such as to cause the second STB 120 to tune to a channel associated with the show and process the show for recording by DVR 130. In one implementation, the option of “3: Record Show On STB-2” may be included in notification message 105 if, for example, the first STB 120 did not include and/or interface with DVR 130 or first STB 120 is inactive.

A selection related to option “4: Send Notification of Next Broadcast” may cause user device 140 to request another notification message 105 identifying a future broadcast of the show (e.g., on the selected station). For example, selection of this option may cause user device 140 to send a request for STB 120 to process EPG data 103 to identify the next broadcast and to initiate a notification message 105 associated with the next broadcast. The request may further cause STB 120 present, via display device 110, a notification 104 associated with the future broadcast. Alternatively, the request may cause STB 120 to initiate a process for sending a notification message 105 without first presenting notification 104.

FIG. 1C merely shows exemplary actions that may be identified in notification message 105. In other implementation, notification message 105 may identify additional, fewer, or different actions than those shown in FIG. 1C. For example, notification message 105 may indicate if the identified program may be accessed via user device 140.

FIGS. 2A and 2B show an exemplary environment 200 (shown in FIG. 2A as environment 200-A and in FIG. 2B as environment 200-B) in which notification message 105 of FIG. 1C may be sent to user device 140 in FIGS. 2A/2B. As shown in FIGS. 2A and 2B, environment 200 may include, for example, customer premises 201 (shown in FIG. 2A as customer premises 201-A and in FIG. 2B as customer premises 201-B) that may include display device 110, first STB 120-1, DVR 130, and user device 140 described above in the discussion of FIGS. 1A-1C. In environment 200-B shown in FIG. 2B, customer premises 201-B may further include second STB-120-2. As further shown in FIGS. 2A and 2B, environment 200 may also include, for example, a network 210; an EPG server 220 that provides EPG data 203 to STB 120-1; and a message server 230 that exchanges request/response data 204 with STB 120-1 in FIG. 2A and with both STB 120-1 and STB 120-2 in FIG. 2B and further exchanges messaging data 205 with user device 140 in FIGS. 2A and 2B.

As described herein, STB 120 may receive data via network 210 and may provide display contents 202 for display by display device 110. Display contents 202 may include, for example, portions of EPG data 203 received by STB 120 from EPG server 220, notification 104, and/or digital content, such as a requested program. For example, STB 120 may include a component to receive and process EPG data 203 from EPG server 220 to generate EPG interface 101. STB 120 may further include a tuner to access a portion of received digital contents (e.g., to provide the program for presentation by display device 110 and/or for recording by DVR 130). For example, the tuner associated with STB 120 may process digital contents to acquire (tune to) a particular channel associated with a show (channel 2 in the examples shown in FIGS. 1A-1C) in response to a selection of option “A: Tune to Show” in notification 104 or a selection of option “1: Tune STB-1 to Show” in notification message 105.

Network 210 may include, for example, a network that distributes or makes available services, such as television services, mobile communication services, and/or Internet services. Network 210 may be a satellite-based network and/or a terrestrial-based network. In implementations described herein, network 210 may support exchanging data/messages to provide notification message 105 to user device 140. Network 210 may include one or more networks of various types including, for example, a cable network (e.g., an optical cable network), a satellite network, a telecommunications network (e.g., a Public Switched Telephone Network (PSTN) or Public Land Mobile Network (PLMN)), an Advanced Television Systems Committee (ATSC) standards network, a local area network (LAN), a wide area network (WAN), a metropolitan area network (MAN), an intranet, the Internet and/or wireless technologies, such as WiFi, WiMax, 2G, 2.5G, 3G, 3.5G, 4G, etc. Network(s) 150 may, in some implementations, include one or more QAM channels (or other types of modulated or broadcast channels) for delivering EPG data 203 and digital contents to STB 120.

EPG server 220 may deliver EPG data 203 that includes information related to EPG interface 101. EPG interface 101 may include television program scheduling information that identifies displays current and upcoming programming provided by a contents service provider (e.g., cable or satellite TV provider). EPG interface 101 may permit a user to navigate through scheduling information interactively, selecting and identifying TV programming by time, station, or title. EPG interface 101 may enable the user to identify desired programming using interactive menus, and a user may interact with STB 120 via EPG interface 101 to request notification 104.

In an implementation described herein, STB 120 may include a component to generate and present notification 104. STB 120 may receive an input requesting notification 104 related to a particular broadcast of a show. For example, a user may select the “A-Request Notification Regarding Show” action option via EPG interface 101 or may provide a different input via a remote control, mobile device, keyboard, mouse, etc. to request notification 104. In another implementation, STB 120 may determine to present notification 104 without receiving a user input. For example, STB 120 may identify shows frequently viewed by a user and may determine a future broadcast of the frequently viewed shows (e.g., another episode in series).

When generating notification 104, STB 120 may process EPG data 203 to identify associated metadata, such as a channel and a broadcast time for the selected show, and STB 120 may generate notification 104 based on the metadata. For example, STB 120 may populate a generic notification form using the metadata from EPG data 203 to create notification 104 (e.g., so that notification 104 includes information identifying the show, the station broadcasting the show, and a time associated with the broadcast) and may cause notification 104 to be presented via display device 110 based on the broadcast time.

A component of STB 120 may further monitor a status of the presentation of notification 104 via display device 110, such as to determine whether display device 110 and STB 120 are active to successfully present notification 104. STB 120 may further determine whether a response (e.g., a selection of one of the action options in notification 104) is received during a particular period of time. If notification 104 is not successfully presented (e.g., display device 110 and/or STB 120 are inactive or not functioning) or a response to notification 104 is not received during the particular period of time (e.g., a user is not at customer premises 201 and/or is not watching display device 110), STB 120 may cause notification message 105 to be sent to user device 140. For example, STB 120 may forward request/response data 204 to message server 230. Request/response data 204 may include data identifying user device 140 and metadata associated with the show, such data identifying the show, a station broadcasting the show, and a broadcast time. The data identifying user device 140 may include, for example, a telephone number, a mobile directory number (MDN), an internet protocol (IP) address, a media access control (MAC) address, a serial number, an electronic serial number (ESN) a mobile equipment identifier (MEID), or an International Mobile Station Equipment Identity (IMEI). In one implementation, STB 120 may provide a graphical user interface (e.g., in EPG interface 101) to receive the data identifying user device 140.

Message server 230 may parse request/response data 204 to extract the metadata regarding the show and may generate messaging data 205 based on the metadata. For example, message server 230 may use the metadata to populate a form. Messaging data 205 may include data that enables user device 140 to present notification message 105. For example, message data 205 may include the contents of notification message 105 and/or an address that enables user device 140 to access the contents of notification message 105.

Message server 230 may forward messaging data 205 to user device 140 based on the data included in request/response data 204. In another implementation, message server 230 may identify user device 140 based on other factors, such as by accessing account records associated with a user of STB 120 to identify user device 140.

Message server 230 may receive, in messaging data 205, information from user device 140 associated with a user input selecting one of the action options displayed in notification message 105. Message server 230 may forward, in request/response data 204, information associated with the selected action option (from notification message) to STB 120 or another component based on the selection. For example, if a user selects the option of “B: Record Show On STB-1,” message server 230 may forward, in request/response data 204, a command to cause DVR 130 to record the show.

In one implementation, message server 230 may forward, in request/response data 204, data associated with a requested action (e.g., data identifying an input received by user device 140 in response to a notification message) to a second device that differs from a first STB 120-1 that originally presented notification 104. For example, as shown in FIG. 2B, message server 230 may forward, in request/response data 204, a message to a second STB 120-2 to cause DVR 130 to record the show. First STB 120-1 and second STB 120-2 may be located in different portions of customer premises 201-B. Alternatively, second STB 120-2 may be located elsewhere, in a different location (not shown). For example, first STB 120-1 may be positioned in a residence associated with a user, and second STB 120-2 may be located at a workplace associated with the user.

The configuration of components of environment 200 illustrated in FIGS. 2A and 2B is for illustrative purposes only, and other configurations may be implemented. For example, environment 200 may include additional, fewer and/or different components than those depicted in FIGS. 2A and 2B. For example, environment 200 may include multiple user devices 140 receiving a notification message 105 from STB 120.

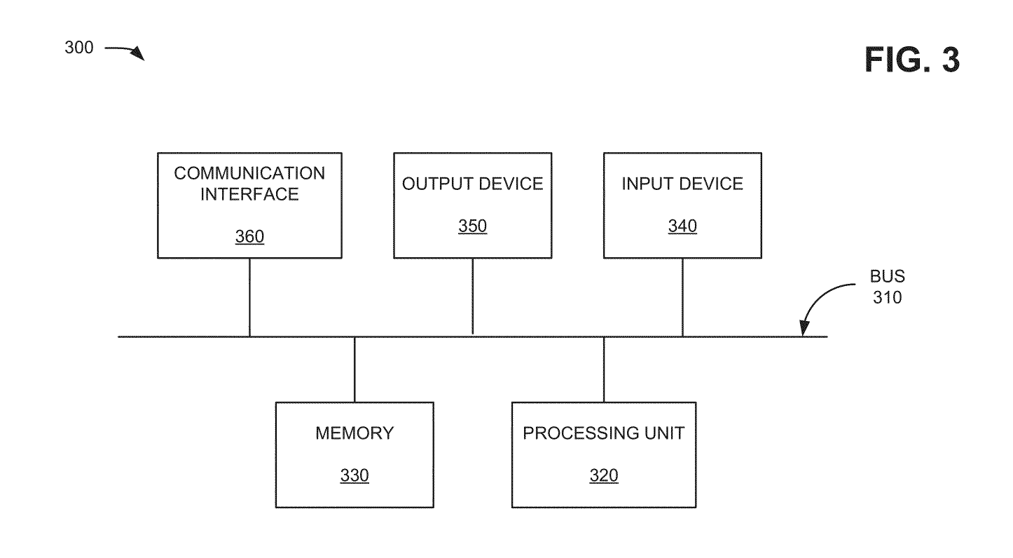

FIG. 3 is a diagram of exemplary components of a device 300 that may be replicated into a plurality of devices, each of which may correspond, respectively, to one or more devices of environment 200 shown in FIG. 2, such as display device 110, STB 120, DVR 130, user device 140, a device (e.g., an intermediate node, router, etc.) of network 210, EPG server 220, or message server 230. In one exemplary implementation, one or more of the devices of environment 200 may include one or more devices 300 or one or more components of device 300. As shown in FIG. 3, device 300 may include a bus 310, a processing unit 320, a memory 330, an input device 340, an output device 350, and a communication interface 360.

Bus 310 may permit communication among the components of device 300. Processing unit 320 may include one or more processors or microprocessors that interpret and execute instructions. In other implementations, processing unit 320 may be implemented as or include one or more application-specific integrated circuits (ASICs), field-programmable gate array (FPGAs), etc.

Memory 330 may include a random-access memory (RAM) or another type of dynamic storage device that stores information and instructions for execution by processing unit 320, a read-only memory (ROM) or another type of static storage device that stores static information and instructions for the processing unit 320, and/or some other type of magnetic or optical recording medium and its corresponding drive for storing information and/or instructions.

Input device 340 may include a device that permits an operator to input information to device 300, such as a keyboard, a keypad, a mouse, a pen, a microphone, a touch screen display, one or more biometric mechanisms, and the like. Output device 350 may include a device that outputs information to the operator, such as a display, a speaker, etc.

Communication interface 360 may include a transceiver that enables device 300 to communicate with other devices and/or systems. For example, communication interface 360 may include mechanisms for communicating with other devices, such as other devices of environment 200. For example, if user device 140 is a wireless device (e.g., a smart phone, a wireless computing device, etc.), communication interface 360 may include a component to communicate via a wireless interface.

As described herein, device 300 may perform certain operations in response to processing unit 320 executing software instructions contained in a computer-readable medium, such as memory 330. A computer-readable medium may be defined as a non-transitory memory device. A memory device may include space within a single physical memory device or spread across multiple physical memory devices. The software instructions may be read into memory 330 from another computer-readable medium or from another device via communication interface 360. The software instructions contained in memory 330 may cause processing unit 320 to perform processes described herein. Alternatively, or additionally, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may include fewer components, different components, differently arranged components, or additional components than those depicted in FIG. 3. Alternatively, or additionally, one or more components of device 300 may perform one or more other tasks described as being performed by one or more other components of device 300.

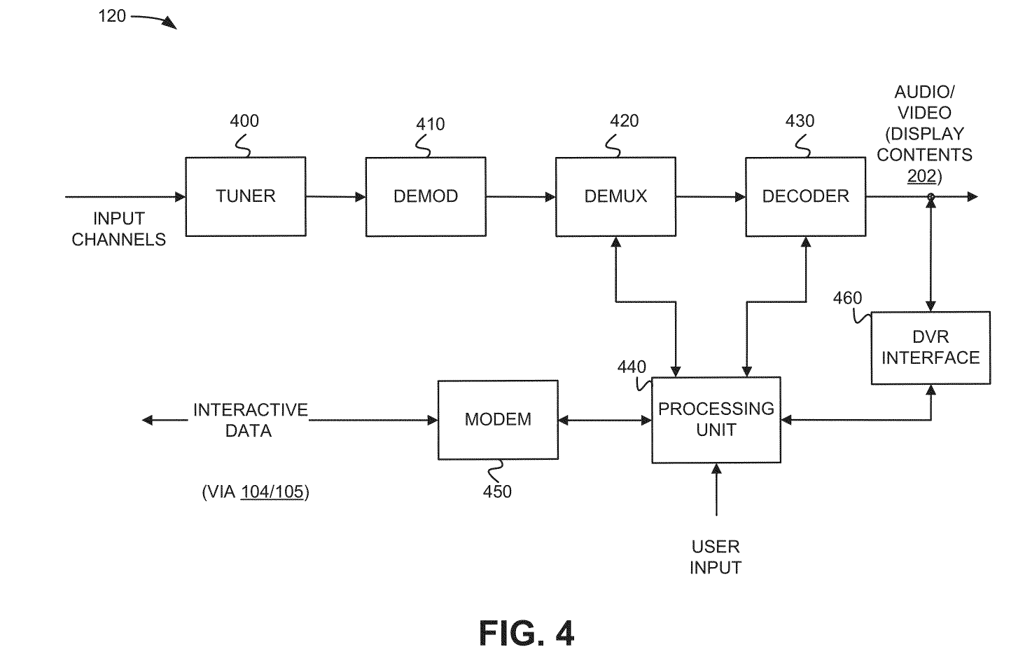

FIG. 4 depicts exemplary components of STB 120. As shown in FIG. 4, STB 120 may include, for example, a tuner 400, a demodulator 410, a demultiplexer 420, a decoder 430, a processing unit 440, a modulator/demodulator (modem) 450, and a DVR interface 460. Tuner 400 may select and tune to specific digital contents (e.g., documents, e-books, audio, video and games, or other data that are stored in a digital format) by tuning to one of many different mulitcast input channels. Each of the input channels may be digitally modulated using, for example, QAM, or other type of modulation, and demodulator 410 may demodulate the information in the channel selected by tuner 400 to produce a transport stream (e.g., such as an MPEG-2 or MPEG-4 transport stream corresponding to containing the audio, video and/or other information related to content be presented by display device 110).

Continuing with FIG. 4, demultiplexer 420 may select and decrypt compressed audio and video from the transport stream for display by display device 110. Decoder 430 may decode and decompress the decrypted audio and video information for the selected digital contents (e.g., digital contents 202). Processing unit 440 may include, for example, a microprocessor that controls the operations performed by tuner 400, demodulator 410, demultiplexer 420, decoder 430, modem 450 and DVR interface 460 based on user input (e.g., input received by STB 120 via a remote control device). Modem 450 may send and receive interactive data (e.g., EPG interface 101, notification 104, and/or notification message 105) that may be processed by processing unit 440. DVR interface 460 may enable STB 120 to exchange digital contents data and instructions to DVR 130, such as to provide decrypted audio and video information (e.g., a station carrying a requested show) to DVR 130 to digitally record and store audio and video contents associated with the particular digital contents decoded by decoder 430. Similarly, STB 120 may receive recorded digital contents data from DVR 130 and may provide related display data for display by display device 110.

Although FIG. 4 shows exemplary components of STB 120, in other implementations, STB 120 may include fewer components, different components, differently arranged components, or additional components than those depicted in FIG. 4. For example, instead of receiving receive EPG data 203 from EPG server 220, STB 120 may include one or more components to process (e.g., to perform visual and/or audio analysis of) digital contents to identify the particular digital contents carried by a selected channel at a particular time. Alternatively or additionally, one or more components of STB 120 may perform one or more other tasks described as being performed by one or more other components of STB 120.

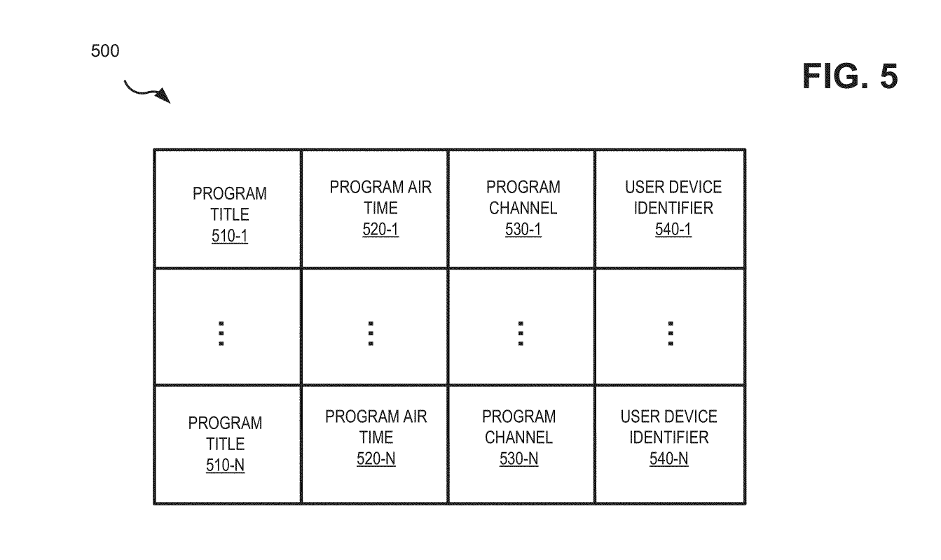

FIG. 5 shows exemplary notification information 500 that may be included in request/response data 204 and/or message data 205 in one implementation. For example, as shown in FIG. 5, notification information 500 may include a program title field 510 (shown in FIG. 5 as program title field 510-1 through program title field 510-N), program air time field 520 (shown in FIG. 5 as program air time field 520-1 through program air time field 520-N), program channel field 530-1 (shown in FIG. 5 as program channel field 530-1 through program channel field 530-N), and user device identifier field 540 (shown in FIG. 5 as user device identifier field 540-1 through user device identifier field 540-N).

Program title field 510 may store data, such as a text string, identifying a program. Program air time field 520 may store data identifying a time when the program, identified in program title field 510, will be broadcasted on a station identified in program channel field 530. Alternatively or additionally, program air time field 520 may store data identifying a time when notification message 105 should be displayed by user device 140. User device identifier field 540 may identify a user device 140 to receive a notification message 105 associated with the program identified in program title field 510. For example, user device field 540 may identify, for example, a telephone number, MDN, IP address, MAC address, MEID, ESN, serial number, IMEI, etc. associated with the user device 140.

In notification information 500, data stored in fields 510, 520, 530, and 540 in a particular horizontal row may be associated with a particular notification 104 and/or notification message 105. For example, program title field 510-1, program air time field 520-1, and program channel field 530-1 of a particular row may be associated with a particular program, and user device identifier field 540 may identify a user device 140 in that row to receive a notification message 105 associated with the particular program.

Although FIG. 5 shows exemplary fields of notification information 500, in other implementations, notification information 500 may include fewer field, different components, differently arranged fields, or additional fields than those depicted in FIG. 5. For example, notification information 500 may include one or more additional fields identifying action options to be presented in notification message 105.

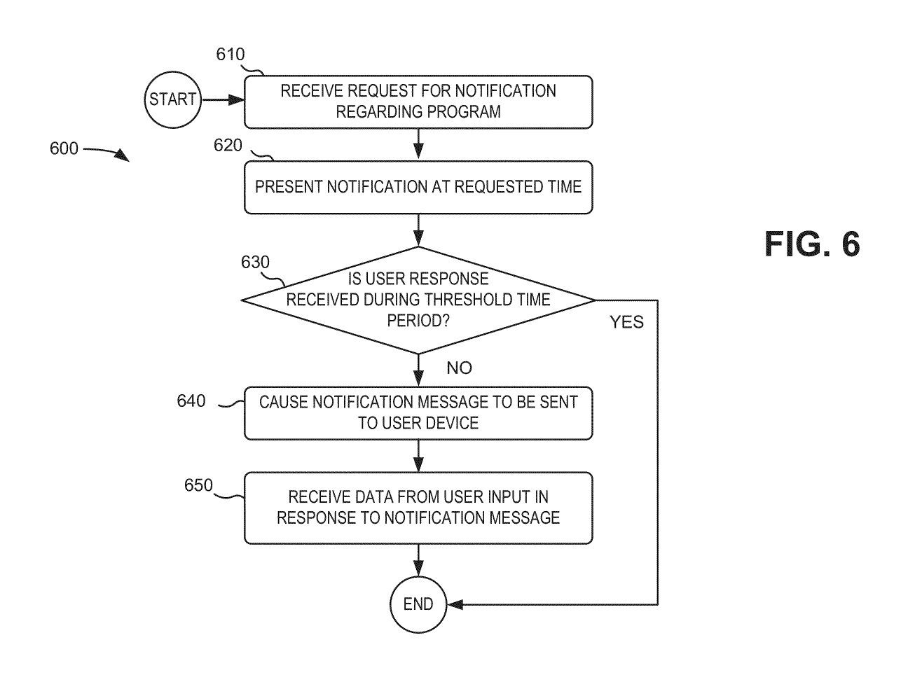

FIG. 6 is a flow diagram of an exemplary process 600 for forwarding notification message 105 to user device 140. Process 600 is described with respect to components in environment 200. In one implementation, process 600 may be performed by STB 120. Alternatively, or additionally, some or all of process 600 may be performed by another device or group of devices, including or excluding STB 120.

As shown in FIG. 6, process 600 may include receiving a request for a notification 104 regarding a program (block 610). For example, a user may submit an input (e.g., via a remote control device) to STB 120 requesting display of notification 104, and notification 104 may indicate that a selected program is available for access to the user. For example, STB 120 may cause display device 110 to present, as shown in FIG. 1A, EPG interface 101 identifying content available via STB 120 at different times on different channels. EPG interface 101 may further enable a user (e.g., via program selection indication 102) to select a particular program and to select a particular action related to the program. For example, as further shown in FIG. 1A, EPG interface 101 may allow a user to request display of notification 104 related to the program, to receive additional data regarding the program, to record the program and/or to add data identifying the program to a watch list.

As shown in FIG. 6, process 600 may further include STB 120 presenting notification 104 at a particular time (block 620). For example, STB 120 may forward display contents 202 that cause display device 110 to present notification 104 at a particular time (e.g., a few minutes before the start of the broadcast). As shown in FIG. 1B, notification 104 may include data identifying the selected program, a channel broadcasting the program, and a broadcast time. Notification 104 may further include action options that, if selected by a user, may initiate certain actions by STB 120 and/or DVR 130.

Continuing with FIG. 6, process 600 may include determining whether a user response to notification 104 is received during a threshold time period (block 630). For example, STB 120 may determine whether a user input selecting one of the action options from notification 104 is received during the threshold time period. Process 600 may end if a user response to notification 104 is received during the threshold time period (block 630-Yes).

As further shown in FIG. 6, process 600 may include causing notification message 105 to be sent to user device 140 for presentation (block 640) if no user response to notification 104 is received during the threshold time period (block 630-No). For example, STB 120 may not receive such selection if the user is not viewing display device 110, the user is not paying attention to display device 110 (e.g., the user is sleeping), display device 110 is inactive, etc. (block 630-No) For example, as shown in FIG. 2A, STB 120 may send request/response data 204 to message server 230, and in response, message server 230 may forward messaging data 205 to user device 140. User device 140 may use messaging data 205 to generate notification message 105.

STB 120 may further receive data from a user input from user device 140 that is submitted in response to notification message 105 (block 650). For example, user device 140 may detect a user input received after presentation of notification message 105, and user device 140 may forward data identifying the user input to STB 120, after which the process ends.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks have been described with regard to FIG. 6, the order of the blocks may be modified in other embodiments. Further, non-dependent blocks in process 600 may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

As used herein, “digital contents” is intended to be broadly defined to include documents, e-books, audio, video and games, or other data that are stored in a digital format.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method comprising:
causing, by a processor associated with a first set-top box (STB), a display device to present a notification to a user during a time period, wherein the notification identifies digital contents that are available for access by the user via the first STB;
determining, by the processor, whether a response to the notification is received from the user during the time period;
identifying, by the processor, a user device associated with the user, wherein the user device differs from the display device;
generating, by the processor, a notification message, wherein generating the notification message includes:
including, in the notification message, an indication that the digital contents are available for access via the first STB,
determining whether the first STB is coupled to a first digital video recorder (DVR),
determining whether the first STB is active during the time period,
identifying a second STB associated with the user, wherein the second STB is coupled to a second DVR,
when the first STB is coupled to the first DVR and when the first STB is active during the time period, including, in the notification message, a first option to record the digital contents on the first DVR, and
when either the first STB is not coupled to the first DVR or the first STB is not active during the time period, including, in the notification message, a second option to record the digital contents on the second DVR; and
causing, by the processor, the notification message to be sent to the user device based on determining that the response to notification is not received from the user during the time period.

2. The method of claim 1, further comprising:
determining whether at least one of the first STB or the display device is inactive during the time period; and
causing the notification message to be sent to the user device during the time period based on determining the at least one of the first STB or the display device is inactive during the time period.

3. The method of claim 1, further comprising:
receiving electronic programming guide (EPG) data;
parsing the EPG data to obtain metadata regarding the digital contents; and
generating the notification message based on the metadata.

4. (canceled)

5. The method of claim 1, further comprising:
receiving, from the user device, response data associated with a selection of one of the first option or the second option;
causing, when the selection corresponds to the first option, the digital contents to be recorded by the first DVR; and
causing, when the selection corresponds to the second option, the digital contents to be recorded by the second DVR.

6. (canceled)

7. The method of claim 1, wherein generating the notification message further includes:
including, in the notification message, a third option to forward another notification message identifying another time period when the digital contents will be available via the first STB, and wherein the method further comprises:
receiving an input associated with a selection of the third option;
determining, based on receiving the input, the other time period when the digital contents will be available via the first STB;
generating the other notification message to include data identifying the other time period; and
causing the other notification message to be sent to the user device.

8. A device comprising:
a memory configured to store instructions; and
a processor configured to implement one or more of the instructions to:
cause a display device to present a notification to a user during a time period, wherein the notification identifies digital contents that are available for access by the user via a first set-top box (STB);
determine whether a response to the notification is received from the user during the time period;
identify a user device associated with the user, wherein the user device differs from the display device;
generate a notification message, wherein the processor, when generating the notification message, is further configured to:
include, in the notification message, an indication that the digital contents are available for access via the first STB,
determine whether the first STB is coupled to a first digital video recorder (DVR),
determine whether the first STB is active during the time period,
identify a second STB associated with the user, wherein the second STB is coupled to a second DVR,
when the first STB is coupled to the first DVR and when the first STB is active during the time period, include, in the notification message, a first option to record the digital contents on the first DVR, and
when either the first STB is not coupled to the first DVR or the first STB is not active during the time period, include, in the notification message, a second option to record the digital contents on the second DVR; and
cause the notification message to be sent to the user device based on determining that the response to notification is not received from the user during the time period.

9. The device of claim 8, wherein the processor is further configured to implement one or more of the instructions to:
determine whether at least one of the first STB or the display device is inactive during the time period; and
cause the notification message to be sent to the user device during the time period based on determining the at least one of the first STB or the display device is inactive during the time period.

10. The device of claim 8, wherein the processor is further configured to implement one or more of the instructions to:
receive electronic programming guide (EPG) data;
parse the EPG data to obtain metadata regarding the digital contents; and
generate the notification message based on the metadata.

11. (canceled)

12. The device of claim 8, wherein the processor is further configured to implement one or more of the instructions to:
receive, from the user device, response data associated with a selection of one of the first option or the second option;
cause, when the selection corresponds to the first option, the digital contents to be recorded by the first DVR; and
cause, when the selection corresponds to the second option, the digital contents to be recorded by the second DVR.

13-14. (canceled)

15. A computer-readable memory device configured to store instructions, the instructions comprising:
one or more instructions that, when executed by a processor, cause the processor to:
cause a display device to present a notification to a user during a time period, wherein the notification identifies digital contents that are available for access by the user via a first set-top box (STB);
determine whether a response to the notification is received from the user during the time period;
identify a user device associated with the user, wherein the user device differs from the display device;
generate a notification message, wherein the one or more instructions further cause the processor, when generating the notification message, to:
include, in the notification message, an indication that the digital contents are available for access via the first STB,
determine whether the first STB is coupled to a first digital video recorder (DVR),
determine whether the first STB is active during the time period,
identify a second STB associated with the user, wherein the second STB is coupled to a second DVR,
when the first STB is coupled to the first DVR and when the first STB is active during the time period, include, in the notification message, a first option to record the digital contents on the first DVR, and
when either the first STB is not coupled to the first DVR or the first STB is not active during the time period, include, in the notification message, a second option to record the digital contents on the second DVR; and
cause the notification message to be sent to the user device based on determining that the response to notification is not received from the user during the time period.

16. The computer-readable memory device of claim 15, wherein one or more instructions further cause the processor to:
determine whether at least one of the first STB or the display device is inactive during the time period; and
cause the notification message to be sent to the user device during the time period based on determining the at least one of the first STB or the display device is inactive during the time period.

17. The computer-readable memory device of claim 15, wherein one or more instructions further cause the processor to:
receive electronic programming guide (EPG) data;
parse the EPG data to obtain metadata regarding the digital contents; and
generate the notification message based on the metadata.

18. (canceled)

19. (canceled)

20. The computer-readable memory device of claim 15, wherein the one or more instructions further cause the processor, when generating the notification message, to:
include, in the notification message, a third option to access the digital contents via the user device.

21. The method of claim 1, further comprising:
determining that first programming is viewed by the user at least a threshold frequency; and
identifying, as the digital content, second programming related to the first programming, wherein the display device is caused to present the notification based on determining that the first programming is viewed by the user at least the threshold frequency.

22. The method of claim 1, wherein the user device is a third STB associated with the user.

23. The device of claim 8, wherein the processor, when generating the notification message, is further configured to:
include, in the notification message, a third option to forward another notification message identifying another time period when the digital contents will be available via the first STB, and
wherein the processor is further configured to:
receive an input associated with a selection of the third option;
determine, based on receiving the input, the other time period when the digital contents will be available via the first STB;
generate the other notification message to include data identifying the other time period; and
cause the other notification message to be sent to the user device.

24. The device of claim 23, wherein the processor, when generating the notification message, is further configured to:
include, in the notification message, a fourth option to access the digital contents via the user device.

25. The device of claim 8, wherein the processor is further configured to:
determine that first programming is viewed by the user at least a threshold frequency; and
identify, as the digital content, second programming related to the first programming, wherein the processor caused the display device to present the notification based on determining that the first programming is viewed by the user at least the threshold frequency.

26. The computer-readable memory device of claim 15, wherein the one or more instructions further cause the processor, when generating the notification message, to:
include, in the notification message, a third option to forward another notification message identifying another time period when the digital contents will be available via the first STB, and
wherein the one or more instructions further cause the processor to:
receive an input associated with a selection of the third option;
determine, based on receiving the input, the other time period when the digital contents will be available via the first STB;
generate the other notification message to include data identifying the other time period; and
cause the other notification message to be sent to the user device.

27. The computer-readable memory device of claim 17, wherein the one or more instructions further cause the processor, when generating the notification message based on the metadata, to:
populate a blank notification form with the metadata to form the notification message.
